(19) United States
(12) Patent Application Publication
(10) Pub. No.: US 2008/0229835 A1
(43) Pub. Date: Sep. 25, 2008

(54) Mullticomponent Backing Block for Ultrasound Sensor Assemblies

(75) Inventors: Richard Davidsen, Everett, WA (US); Shon Schmidt, Seattle, WA (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/916,762

(22) PCT Filed: Jun. 5, 2006
(86) PCT No.: PCT/IB2006/051785

§ 371 Date: Dec. 6, 2007

Related U.S. Application Data
(60) Provisional application No. 60/688,007, filed on Jun. 7, 2005.

(51) Int. Cl. G01N 29/00

(52) U.S. Cl. 73/629

(57) ABSTRACT

Backing block (16) for interconnecting a transducer array (12) and interconnection cables (18) connecting the transducer array (12) to a main system processing unit of an ultrasound imaging system which includes at least one base electronic component (24) electrically connected to the interconnection cable(s) (18) and which provides a pattern of interconnection structures (28), a redistribution interposer (22) electrically coupled on one side (40) to the base components) (24) and on an opposite side (38) to transducer array (12), and at least one subsidiary electronic component (26) supported by the base component(s) (24). The subsidiary components (26) can be arranged alongside the redistribution interposer (22), i.e., on a common side of the base component(s) (24) therewith, since the redistribution interposer (22) tapers in at least one dimension so that it has a smaller pitch on the side (40) connected to the base component(s) (24) than on the side (38) connected to the transducer array (12).

The present invention relates generally to ultrasound imaging systems, and more particularly, to a backing block for an ultrasound transducer array and a method for processing signals being transmitted to and received by an ultrasound transducer array in ultrasound imaging systems.

The present invention also relates to ultrasound sensor assemblies including a transducer array and a backing block including a hybrid microbeamformer which connects the transducer array to interconnection cables leading to a main ultrasound imaging system processing unit.

In ultrasound imaging systems, transducer arrays are generally used for transmission and reception of ultrasonic or acoustic waves. Volumetric imaging, i.e. interrogation of a substantially three-dimensional region of interest, is obtained through use of a multi-D transducer array, e.g., a two-dimensional array of transducer elements.

In one type of ultrasound transducer design, the transducer elements are attached and individually electrically connected to a surface of an application specific integrated circuit (ASIC). The ASIC is often referred to as a microbeamformer and provides electrical control of the transducer elements, such as, for beam forming, signal amplifying, etc., and interfaces between the transducer elements and signal processing channels of the ultrasound imaging system via interconnection cables.

Practical implementation of multi-D transducer arrays with microbeamformers requires a host of tradeoffs in performance, power dissipation, form factor, cost and time to market. One particular set of tradeoffs revolves around the design of the ASICs and their relationship to the interconnection structure which connects the ASICs to the transducer elements. Two approaches have been considered to date: geometrically constrained, pitch matched ASICs with a “flip-chip” interconnection and geometrically unconstrained ASICs with a “flex in backing” interconnection.

The flip-chip approach, which is based on electrical interconnection using small conductive bumps such as solder balls, has the advantages of low power, small form factor, low cost and complexity, but has limited re-use, if any, and is subject to imaging artifacts due to unintended acoustic interactions within the interconnection structure. On the other hand, the “flex in backing” approach has the advantages of better potential performance and ASIC re-use, but its disadvantages are that it is bulky, complex and costly. The present invention seeks to overcome the disadvantages of both the flip-chip approach and the flex in backing approach.

In an interconnection structure using a typical flip-chip architecture, the microbeamformer is the same size as the acoustic aperture, which is tailored to the imaging application, and is comprised of cells that are pitch-matched to the array pitch. Providing all of the necessary functionality and performance within this size limitation is extremely challenging and requires significant compromises. These compromises include using lower voltage ASIC processes with finer feature sizes to fit in the available space in the transducer housing at a cost of reduced penetration, and the substantial elimination of the ability to re-use the ASICs (which results from the pitch matching). Another compromise is that the limited space in the transducer housing creates an increase in pressure to only implement minimal functionality of the ASICs with compromises and approximations where necessary. Furthermore, since the cells of the ASICs are located under each transducer element, the ASICs have both analog and digital functional components intimately mixed throughout the microbeamformer.

A significant ASIC limitation of the flip-chip approach is that the beamforming electronics must reside within the area of the transducer array. Unfortunately, this constraint often results in optimizations and performance trade-offs that degrade image quality or cause image artifacts. In addition, the heat is more directly transferred through the transducer array to the patient, resulting in more stringent power requirements.

An interconnection using the flex in backing approach is described generally in U.S. Pat. Pub. No. 20030085635, incorporated by reference herein, and entails constructing a conductive backing block assembly from alternating layers of flex circuits and plates of backing material which are laminated together with an adhesive. The assembly is cured under pressure in a heated press such that the top surface, to which connections are made to the transducer elements, is ground to a smooth finish and preferably gold plated for attachment to the underside of the transducer elements. One method for connecting the conductive backing block assembly to the transducer elements is by adhesive attachment using a low viscosity adhesive such as an epoxy.

It would be desirable to have an interconnection structure for connecting transducer elements of a transducer array to a microbeamformer comprised of a plurality of electronic components which provides a backing block formed thereby with a minimal size to enable it to fit within a small size transducer housing, yet also allow higher voltages and improved functionality and premium performance.

It is an object of the present invention to provide new and improved ultrasound imaging systems and more specifically ultrasound sensor assemblies therefor which include a multi-D transducer array and a microbeamformer.

It is another object of the present invention to provide a new and improved microbeamformer for an ultrasound imaging system in which analog and digital functions are performed by separate electronic components optimized for specific purposes.

It is another object of the present invention to provide a new interconnection structure for an ultrasound imaging system, referred to as a backing block, which provides connections between transducer elements of a transducer array and one or more interconnection cables connecting to a main ultrasound imaging system processing unit.

It is yet another object of the present invention to provide a new backing block for interconnecting transducer elements of a transducer array in an ultrasound imaging system and a plurality of electronic components forming a microbeamformer which has a minimal size to enable it to fit within a small size transducer housing, yet also allow higher voltages and improved functionality and premium performance.

It is yet another object of the present invention to provide a new backing block for an ultrasound sensor assembly which enables electronic components thereof to be easily replaced and thereby enable the backing block to be re-used and optimized for different sensor assemblies and for different ultrasound applications.

It is still another object of the present invention to provide a new backing block for an ultrasound imaging system including a multi-chip microbeamformer and a redistribution structure interposed between the microbeamformer and a transducer array which enables the transducer array to have a different size than the microbeamformer. In order to achieve these objects and others, a backing block for interconnecting an array of transducer elements in an ultrasound transducer array of an ultrasound imaging system and a main processing unit of the ultrasound imaging system includes at least one base electronic component coupled to the main processing unit and which provides a pattern of interconnection structures (e.g., bond pads and wiring), a redistribution interposer electrically coupled on one side to the interconnection structures on the base component(s) and on an opposite side to the array of transducer elements, and at least one subsidiary electronic component electrically coupled to the interconnection structure on the base component(s). Each base component can be coupled to the system processing unit in a wired or wireless manner, e.g., via one or more interconnection cables connected to the interconnection structures. Each subsidiary component is arranged alongside the redistribution interposer such that the redistribution interposer and the subsidiary component(s) are disposed on a common side of the base component(s). Space for mounting the subsidiary component(s) on the same side of the base component(s) is preferably provided by tapering of the redistribution interposer which, in at least one dimension, has a smaller pitch on the side connected to the base component(s) than on the side connected to the transducer elements of the array.

Each base component is preferably a high voltage application specific integrated circuit while each subsidiary component is preferably a low voltage application specific integrated circuit. Alternatively, the base and subsidiary components may be other types of electronic components which can be designed or programmed to perform specific functions relating to signal processing in general and beamforming in particular, such as Field Programmable Gate Arrays (FPGAs), custom analog or digital processing engines, sub-beamformers or super-beamformers, low noise analog circuits, or cabled or wireless communication modules.

More specifically, each base component may be designed to perform one or more beamforming functions such as to amplify a receive signal and transmit a high voltage output signal to the transducer elements and pre-amplify received signals from the transducer elements. To this end, each base component could include a transmit amplifier and a receive pre-amplifier. Each subsidiary component may also be designed to perform one or more beamforming functions such as a signal processing function, e.g., pre-amplify a signal. To this end, each subsidiary component could include a pre-amplifier.

In one particular embodiment, subsidiary components include a radio frequency (RF) modulator/transmitter, in which case, data would be transmitted wireless between the backing block and the system processing unit and interconnection cables would not be used to connect the backing block to the system processing unit. Other wireless transmission and reception components could also be used as subsidiary components.

Regarding the electrical connection of the redistribution interposer and subsidiary component(s) to the bond pads provided by the base component(s), the redistribution interposer is preferably connected to bond pads in a central region of the base component(s) while each subsidiary component is preferably connected to bond pads in a lateral region of the base component(s) outward of the central region. Each interconnection cable is preferably connected to bond pads at extreme lateral or peripheral edges of the base component(s) so that the space available for electrical interconnection to the base component(s) is maximized.

An ultrasound sensor assembly in accordance with the invention would therefore comprise an array of transducer elements for transmitting and receiving pulses, a microbeamformer for controlling transmission and reception of the pulses by the array of transducer elements, and a redistribution interposer electrically coupled on a first side to the array of transducer elements and on a second, opposite side to the microbeamformer. In one embodiment, the microbeamformer includes separate integrated circuits for performing either analog or digital functions, e.g., separate HVICs and LVICs, with the functionality of each being optimized as desired (or other electronic components capable of performing the same or other signal processing or specific beamforming functions as described above). The HVICs are electrically connected via a pattern of interconnection structures, such as bond pads formed thereon, to the interconnection cable(s), the LVICs and the redistribution interposer. The same enhancements as described for the backing block above can be applied in the sensor assembly as well.

A method for interconnecting an array of transducer elements and one or more interconnection cables of an ultrasound probe using the above-described interconnection structure may entail electrically connecting the array to one side of a redistribution interposer, electrically connecting an opposite side of the redistribution interposer to one or more base components which provide a pattern of interconnection structures, electrically connecting one or more subsidiary components to the interconnection structures of a base component alongside the redistribution interposer such that the redistribution interposer and the subsidiary component are arranged on a common side of the base component(s), and electrically connecting the base component(s) to the interconnection cable(s). The base component(s) may be attached to the redistribution interposer using a low temperature flip chip process. The foregoing steps may be performed in the order listed above or in a different order.

The invention, together with further objects and advantages thereof, may best be understood by reference to the following description taken in conjunction with the accompanying drawings wherein like reference numerals identify like elements.

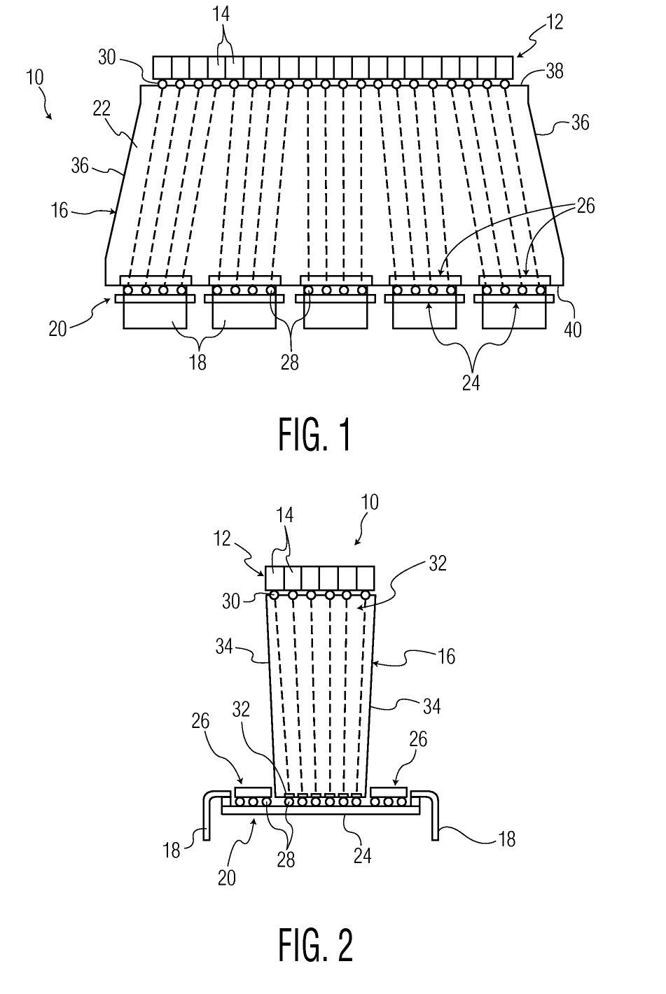

FIG. 1 is a side view of an ultrasound sensor assembly in accordance with the invention.

FIG. 2 is a different side view of the ultrasound sensor assembly shown in FIG. 1.

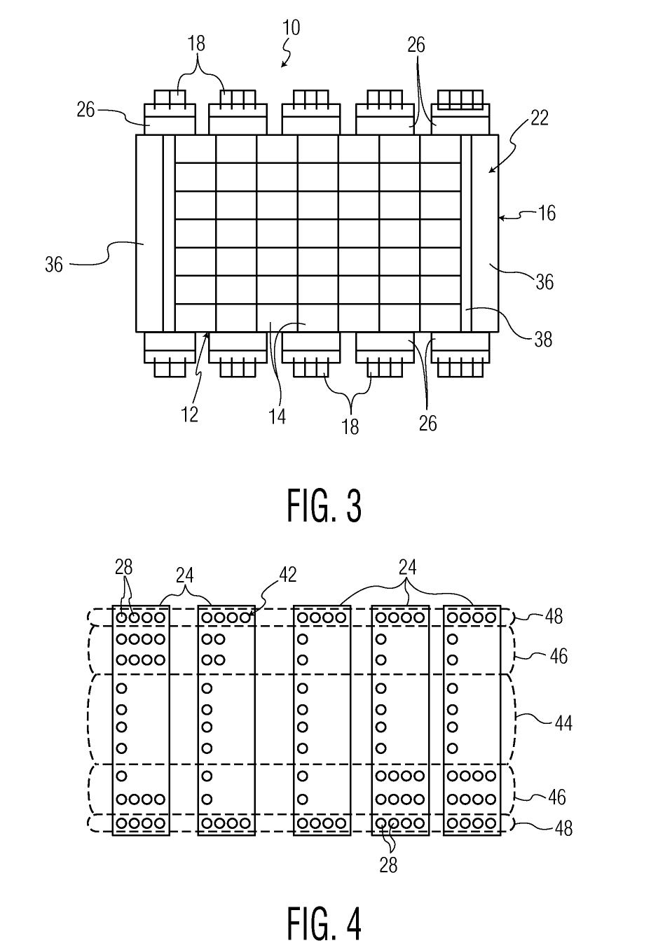

FIG. 3 is a top view of the ultrasound sensor assembly in FIG. 1.

FIG. 4 is a top view of the base components of the ultrasound sensor assembly shown in FIG. 1.

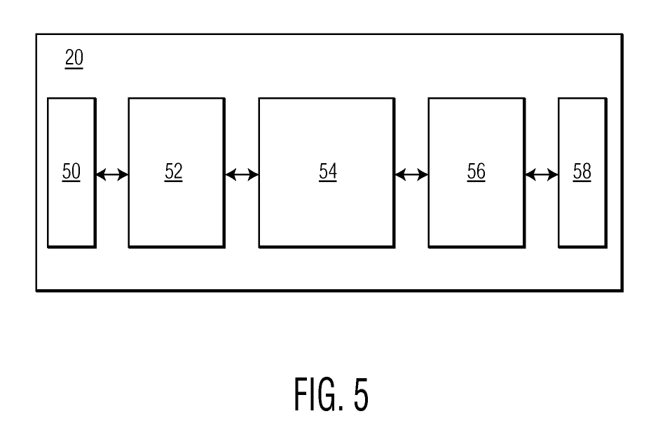

FIG. 5 is a schematic of the multi-component backing block in accordance with the invention.

Referring to FIGS. 1-5, an ultrasound sensor assembly for an ultrasound transducer in accordance with the invention is designated generally as 10 and includes an array 12 of transducer elements 14 and an interconnection structure, referred to as a backing block 16 herein, which is interposed between and interconnects the array 12 and flexible interconnection cables 18 which lead to an image processing and display unit of the ultrasound imaging system (not shown). Backing block 16 includes a microbeamformer 20 and a redistribution interconnection device or redistribution interposer 22. The sensor assembly 10 may be arranged in a common, transducer housing which is movable relative to the ultrasound imaging system.

Microbeamformer 20 includes a plurality of base components 24 which define a pattern of interconnection structure, namely contacts pads, bond pads or another type of conductive connecting member 28, on one side which enable the redistribution interposer 22 and a plurality of subsidiary electronic components 26 to be electrically connected thereto. The interconnection structure also includes wiring between the bond pads 28 and electronic parts of the base components 24. Base components 24 may be high voltage integrated circuits (HVICs), specifically application specific integrated circuits (ASICs), and subsidiary components 26 may be low voltage integrated circuits (LVICs), specifically application specific integrated circuits (ASICs), and/or Field Programmable Gate Arrays (FPGAs).

The functions necessary for beamforming to be performed by the microbeamformer 20 are assigned to specific ones of the base or subsidiary components 24, 26 depending, for example, on the construction of the components and which type of component is best capable of performing that function. In an embodiment wherein HVICs are used as the base components 24 and LVICs are used as the subsidiary components 26, the electronic functions of the microbeamformer 20 are therefore implemented in separate high voltage and low voltage components, and specifically in the type of component which provides for optimum performance.

Generally, each base component 24 includes a driver for generating a transmit pulse to be transmitted to the transducer elements 14 to cause the transducer elements 14 to produce a transmit beam and each subsidiary component 26 includes circuits for generating transmit waveforms that serve as inputs to the base components 24, time delay circuits for receiving reflected pulses from the transducer elements 14 and delaying the reflected pulses and/or a summation circuit for summing groups of the delayed reflected pulses in order to produce beamformed signals. Other functions capable of being performed by the subsidiary components 26 include phase aberration correction, focus control, speed of sound correction, multi-beam processing, sub-microbeamforming, cross-correlation, data processing, and complete beamforming. The base components 24, since they are the first electronic component to receive signals from the transducer elements 14, may also include receive pre-amplifiers which amplify the receive signals from the transducer elements 14. The construction of the base components 24 and subsidiary components 26 are thus different depending, for example, on the particular application thereof.

The presence of different types of electronic components in the microbeamformer 20 having different constructions and assigned functions, for example, both HVICs and LVICs, provides a solution to the problem of compromising on performance of a microbeamformer. The analog and digital functions being performed by the microbeamformer 20 in accordance with the invention are separated, with each being performed optimally either by an HVIC or an LVIC, or other equivalent electronic component, such as Field Programmable Gate Arrays (FPGAs), custom analog or digital processing engines, sub-beamformers or super-beamformers, low noise analog circuits, or cabled or wireless communication modules. The tradeoffs between power consumption, circuit complexity and power transmission are therefore advantageously accommodated.

Redistribution interposer 22 is designed to interconnect the bond pads 28 on the upper surface of the base components 24 to the transducer elements 14 via conductive material within and on the upper and lower exposed surfaces thereof. The connection of the transducer elements 14 to the redistribution interposer 22 may be obtained via the formation of conductive material 30 therebetween using a standard transducer fabrication process (see FIGS. 1 and 2). Connection of the base component bond pads 28 to the redistribution interposer 22 may be obtained via the formation of conductive material 32 therebetween using, e.g., a sliver epoxy dipping process. It is possible to provide bond pads on both surfaces of the redistribution interposer 22 to connect to the base component bond pads 28 and transducer elements 14.

In addition to interconnecting the base components 24 of the microbeamformer 20 to the transducer elements 14 of the array 12, an important purpose of the redistribution interposer 22 is to decouple the spatial constraints on the microbeamformer 20 from the spatial constraints of the array 12 of transducer elements 14 so that the foot-print of the array 12 can be different than the foot-print of the bond pads 28 on the base components 24. In the illustrated embodiment, the redistribution interposer 22 tapers outward from the base components 24 on one pair of opposite edges or sides 34 (see FIG. 2) and inward from the base components 24 on the other pair of opposite edges or sides 36 (see FIG. 1). Thus, in one dimension, the side 38 of the redistribution interposer 22 to which the transducer elements 14 are connected is larger than the side 40 of the redistribution interposer 22 to which the base components 24 are connected while in the other, perpendicular dimension, side 38 is smaller than side 40 (see FIG. 1). The degree of tapering of the sides 34, 36 of the redistribution interposer 22 is based on various factors, for example, the bond pad pitch. Indeed, since the bond pad pitch for flip-chip bonding the base components 24 can be as tight as 100 microns, significant tapering is possible. On the other hand, since the transducer housing is typically slightly larger in the elevation dimension than the apertures thereof, some extra space is available in addition to space provided by the tapering.

Redistribution interposer 22 is also effective to isolate the base components 24 and the transducer elements 14 to thereby reduce acoustic artifacts arising from interaction between the base components 24 and the transducer elements 14.

Alternative constructions of the redistribution interposer 22 for use with transducer arrays having various shapes are disclosed in U.S. patent application Ser. No. 60/642,911 (Attorney Docket No. PHUS050020US) filed Jan. 11, 2005, incorporated by reference herein. For example, a curved transducer array can be provided and connected to the base components 24 using a redistribution interposer having a linear lower surface and an opposed curved surface as disclosed in this application.

In the illustrated embodiment, there are five HVICs as base components 24, ten LVICs as subsidiary components 26 and each HVIC has an array 42 of bond pads 26 formed on the upper surface (see FIG. 4). The redistribution interposer 22 is connected to the first set of bond pads 28 in a central interconnect section 44 of the bond pad array 42 and a pair of LVICs, which are the subsidiary components 24, are connected to a second set of bond pads 28 arranged in lateral sections 46 outward from the central interconnect section 44. The LVICs, which connect to the bond pads 28 in lateral sections 46, are therefore arranged alongside the redistribution interposer 22, which connects to the bond pads 28 in the central interconnect section 44. Flex circuits of the interconnection cables 18 are connected to a third set of bond pads 28 in peripheral sections 48 outward from the lateral sections 46. Each section 44, 46, 48 includes bond pads 28 from multiple HVICs 24 so that each HVIC 24 is connected to the redistribution interposer 22, a pair of LVICs 26 and a pair of interconnection cables 18. However, depending on the number and size of the LVICs 26, it is possible for each HVIC 24 to be connected to fewer elements, e.g., the redistribution interposer 22, a single LVIC 26 and a single interconnection cable 18.

FIG. 5 shows the general structure of the microbeamformer 20 which includes an input/output (I/O) section 50 which receives signals to cause the transmission of ultrasound pulses via the transducer array 12, an initial signal processing section 52 containing LVICs or comparable subsidiary components which perform one or more signal processing functions such as amplification, delay and transmit waveform generation, a primary signal processing section 54 containing HVICs or comparable base components which perform one or more signal processing functions such as high voltage transmission and pre-amplification (and to which the redistribution interposer 22 would be connected), a final signal processing section 56 containing LVICs or comparable subsidiary components which perform one or more signal processing functions on the receive signals and an input/output (I/O) section 58 which outputs the processed receive signals. The interconnections between the various sections and components is provided by the interconnection structure of each HVIC, e.g., bond pads formed on one surface thereof and wiring between the bond pads and parts of the HVIC.

As shown in FIGS. 1-3, there are interconnection cables 18 which connect the base components 24 to the system processing unit. Instead of providing interconnection cables, it is possible to provide as subsidiary components 26 or a part thereof, a radio frequency (RF) modulator/transmitter, in which case, data can be transmitted wirelessly between the subsidiary components and the system processing unit. Thus, the transmission of data between the microbeamformer 20 and the system processing unit may be done in a wired or wireless manner. RF modulator/transmitters can thus be part of the signal processing sections 52, 56, or alternatively, part of the I/O sections 50, 58.

A general embodiment of a backing block in accordance with the invention or an ultrasound sensor assembly including the backing block and an array of transducer elements in accordance with the invention may have as little as a single base component such as an HVIC, and a single subsidiary component such as an LVIC and a redistribution interposer bonded to bond pads on the upper surface of the HVIC. This might be appropriate for a small array with only a few transducer elements. As the size of the array increases, the number of HVICs, the number of LVICs and the size of the redistribution interposer would increase.

There are several advantages to the combination of a microbeamformer 20 including separate electronic components which perform different functions depending on their constructions, e.g., both HVICs and LVICs, and a redistribution interposer 22 which obviates the pitch-matching requirement when using flip-chip bonding interconnection for the microbeamformer. Advantages include the ability to fabricate digital circuits using low voltage, low power, high density ASIC technology that has a great degree of functionality using available standard cell libraries, the ability to confine high voltage analog circuits to high voltage ASICs that have larger feature sizes but can easily fit in the available space since there is no digital functionality, and the overall partitioning of digital and analog sections away from each other, thereby reducing potential noise and interference. In addition, the size and weight of the interconnection structure is similar to flip chip interconnections while providing an improvement over flex in backing interconnection designs.

Furthermore, if the interconnection structure defined by the base component(s) is standardized, it would allow ASIC reuse with changes to the redistribution interposer to accommodate different array pitches. That is, it is conceivable that the LVICs can be replaced with upgraded LVICs as new designs become available without requiring any changes in the manufacturing process, described below. The base components 24 or HVICs would remain as part of the microbeamformer 20 while the subsidiary components 26 or LVICs would be replaced to constitute an upgrade of the microbeamformer 20.

Moreover, various LVICs with different capabilities can be manufactured at the same time and made available for selection by customers to integrate into the sensor assembly 10. Thus, using the same base components 24 or HVICs and the same redistribution interposer 22, different microbeamformers 20 (and thus different backing blocks 16 and different sensor assemblies 10) could be produced by varying the capability of the subsidiary components 26 or LVICs mounted onto the base components 24 of HVICs. The price of each sensor assembly 10 could depend on the capability of the subsidiary components 26 or LVICs therein.

Another advantage is that since the lead lengths from linear amplifiers to the elements are short, little power is wasted in driving interconnect capacitance. Also, since the high voltage ASIC technology can be selected without regard to digital feature sizes, compromises that lead to lower voltage output can be eliminated and penetration and image quality can be improved.

An ultrasound sensor assembly 10 including the array 12 of transducer elements 14, the backing block 16 and the interconnection cable(s) 18 can be manufactured in a variety of different ways. One exemplifying manufacturing method is to electrically connect the transducer elements 14 of the array 12 to bond pads on the upper surface of the redistribution interposer 22, for example, using a standard transducer fabrication process. Bond pads 28 on the base components 24 (those in section 44) are electrically connected to bond pads on the lower surface of the redistribution interposer 22, e.g., via a low temperature flip chip process or a silver epoxy dipping process, with the bond pads on the lower surface of the redistribution interposer 22 being electrically connected to the bond pads on the upper surface of the redistribution interposer 22 through electrical connections within the redistribution interposer 22. The subsidiary components 26 are electrically connected to bond pads 28 on the periphery of the base components 24 (those in section 46), e.g., using a flip chip interconnection. The interconnection cables 18 are electrically connected to additional bond pads 28 on the periphery of the base components 24 (those in section 48).

Since the redistribution interposer 22 is preferably formed using a flex in backing technique, the construction of sensor assembly 10 therefore involves using both the flip-chip interconnection technique and the flex in backing technique. Use of both fabrication techniques leads to a hybrid design with the disadvantages of each individual technique being reduced or eliminated. A more favorable tradeoff for design purposes is therefore rendered possible.

The order in which the ultrasound sensor assembly 10 is assembled, i.e., the order in which the electrical connections between the components is made, is variable. A preferred order of electrical connections is to first connect the transducer elements 14 to the redistribution interposer 22, then connect the subsidiary components 26, such as LVICs, to the base components 24, such as HVICs, then connect the interconnection cables 18 to the HVICs 24 and finally connect the HVICs 24 to the redistribution interposer 22. The assembly of the HVICs 24 and LVICs 26 can also be tested prior to connecting the HVICs 24 to the redistribution interposer 22. Finally, once the sensor assembly 10 is complete, it can be tested.

Furthermore, during assembly of the sensor assembly 10, various testing of the components may be performed. For example, the connection between the transducer elements 14 and redistribution interposer 22 may be tested after these components are connected together.

The sensor assembly 10 can be used in any type of ultrasound imaging system including an ultrasound transducer, for example, medical ultrasound imaging systems. It would be particularly useful for those applications where dense interconnection of low and high voltage electronics, with an interconnection to a transducer array, is needed.

Although illustrative embodiments of the present invention have been described herein with reference to the accompanying drawings, it is to be understood that the invention is not limited to these precise embodiments, and that various other changes and modifications may be effected therein by one of ordinary skill in the art without departing from the scope or spirit of the invention.

1. A backing block (16) for interconnecting an array (12) of transducer elements (14) in an ultrasound transducer and a processing unit of an ultrasound imaging system, comprising:
at least one base electronic component (24) defining a pattern of interconnection structure (28) on a first side thereof;
a redistribution interposer (22) electrically coupled on a first side (40) to said interconnection structure (28) on said first side of said at least one base component (24) and adapted to be electrically coupled on a second, opposite side (38) to the array (12) of transducer elements (14); and
at least one subsidiary electronic component (26) electrically connected to said at least one base component (24) on said first side thereof via said interconnection structure (28) and arranged alongside said redistribution interposer (22).

2. The backing block (16) of claim 1, wherein said at least one base component (24) comprises a driver for generating a transmit pulse to be transmitted to the transducer elements (14) to cause the transducer elements (14) to produce a transmit beam and said at least one subsidiary component (26) comprises circuits for generating transmit waveforms that serve as inputs to said at least one base component (24) and time delay circuits for receiving reflected pulses from the transducer elements (14) and delaying the reflected pulses and a summation circuit for summing groups of the delayed reflected pulses in order to produce beamformed signals.

3. The backing block (16) of claim 1, wherein said at least one base component (24) comprises a high voltage integrated circuit and said at least one subsidiary component (26) comprises a low voltage integrated circuit.

4. The backing block (16) of claim 1, wherein said at least one subsidiary component (26) comprises a pair of subsidiary components, said redistribution interposer (22) being arranged between said subsidiary components (26).

5. The backing block (16) of claim 1, wherein said at least one base component (24) comprises a plurality of base components and said at least one subsidiary component (26) comprises a plurality of subsidiary components, said subsidiary components (26) being arranged such that said redistribution interposer (22) is interposed between at least one pair of said subsidiary components (26).

6. The backing block (16) of claim 1, wherein said redistribution interposer (22) tapers inward from said first side (40) to said second side (38) along at least one edge extending between said first and second sides (38, 40).

7. The backing block (16) of claim 1, wherein said interconnection structure (28) comprises bond pads formed on a periphery of said at least one base component (24) around said redistribution interposer (22).

8. The backing block (16) of claim 7, wherein said at least one subsidiary component (26) is bonded to a portion of said bond pads (28).

9. The backing block (16) of claim 7, wherein at least a portion of said bond pads (28) enable electrical bonding with at least one interconnection cable (18) leading to the system processing unit.

10. The backing block (16) of claim 1, wherein said at least one subsidiary component (26) comprises a radio frequency modular/transmitter for wirelessly coupling the backing block (16) to the system processing unit.

11. A sensor assembly (10), comprising:
the backing block (16) of claim 1;
an array (12) of transducer elements (14) for transmitting and receiving pulses and connected to said second side (38) of said redistribution interposer (22); and
at least one interconnection cable (18) connected to said at least one base component (24).

12. A method for interconnecting an array (12) of transducer elements (14) and an ultrasound probe, comprising:
electrically connecting the array (12) to one side (38) of a redistribution interposer (22);
electrically connecting an opposite side (40) of the redistribution interposer (22) to at least one base component (24) which defines a pattern of interconnection structure (28);
electrically connecting at least one subsidiary component (26) to the at least one base component (24) alongside the redistribution interposer (22) such that the redistribution interposer (22) and the at least one subsidiary component (26) are arranged on a common side of the at least one base component (24), the at least one subsidiary component (26) having a different function than the at least one base component (24);
coupling the at least one base component (24) to the ultrasound probe in a wired or wireless manner; and
constructing the at least one base component (24) and the at least one subsidiary component (26) differently and assigning different functions to the at least one base component (24) and the at least one subsidiary component (26) based on their construction.

13. The method of claim 12, further comprising attaching the at least one base component (24) to the redistribution interposer (22) using a low temperature flip chip process.

14. The method of claim 12, wherein the interconnection structure (28) includes contact pads, further comprising:
connecting the redistribution interposer (22) to a first set of bond pads (44) in an interior of the at least one base component (24);
connecting the at least one subsidiary component (26) to a second set of bond pads (46) around the first set of bond pads (44); and
connecting at least one interconnection cable (18) to a third set of bond pads (48) around the second set of bond pads (46).

15. The method of claim 12, wherein a plurality of subsidiary components (26) are connected to the at least one base component (24) such that the redistribution interposer (22) is interposed between at least one pair of subsidiary components (26).

16. The method of claim 12, wherein the interconnection structure (28) includes bond pads, further comprising standardizing the arrangement of the bond pads on each of the at least one base component (24) to enable the at least one subsidiary component (26) to be used for different base components.

17. The method of claim 12, further comprising removably attaching the at least one subsidiary component (26) to the at least one base component (24) to enable removal and replacement of the at least one subsidiary component (26).

18. The method of claim 12, wherein the at least one base component (24) is coupled to the ultrasound probe wirelessly by arranging a radio frequency modular/transmitter as one of the at least one subsidiary component (26).
